(19) United States
(12) Patent Application Publication
(10) Pub. No.: US 2021/0073839 A1
(43) Pub. Date: Mar. 11, 2021

(54) MAP VISUALIZATION FOR WELL DATA

(71) Applicant: DRILLING INFO, INC., Austin, TX (US)

(72) Inventor: Ajit Thomas, Fresno, CA (US)

(21) Appl. No.: 16/772,073

(22) PCT Filed: Dec. 12, 2018
(86) PCT No.: PCT/US2018/065217

§ 371 Date: Jun. 11, 2020

Related U.S. Application Data
(60) Provisional application No. 62/597,857, filed on Dec. 12, 2017.

(51) Int. Cl. G06Q 30/02; G06F 16/951; G06F 16/954; G06F 16/958; G06F 16/906; G06F 16/29; G06Q 50/02; G06N 20/00; G06N 5/04; G06F 40/205

(52) U.S. Cl. CPC G06Q 30/0205; G06F 16/951; G06F 16/954; G06F 16/958; G06F 16/906; G06F 40/205; G06Q 30/0201; G06Q 50/02; G06N 20/00; G06N 5/04; G06F 16/29

(57) ABSTRACT

Techniques for include map visualization for well data include navigating websites and aggregating well data information in a database; processing the aggregated well data information to extract a first set of well data; navigating to online websites and obtaining a second set of well data based on the extracted first set of well data; generating entries for the extracted first and second set of well data in a searchable structured database; and in response to user input, displaying, in a graphical user interface (GUI), the well data stored in the database.

### CLAIM OF PRIORITY

The application claims priority to U.S. Provisional Patent Application Ser. No. 62/597,857, filed on Dec. 12, 2017, and entitled “Map Visualization for Well Data from Company Disclosures,” the entire contents of which are incorporated by reference herein.

### TECHNICAL FIELD

The disclosed implementations relate generally to digital maps, and, in particular, to computer-implemented techniques for generating maps to visualize oil and gas well data using indirect information sources.

### BACKGROUND

Upstream oil and gas companies desire to track the operational activities of other companies in the oil and gas industry as part of competitive intelligence gathering practices. Among other things, the companies collect and analyze oil and gas or other natural resource well data that includes information about well design, well performance, and operational efficiencies. The information may include drilling days, the lateral length of the well, production rate over a specific time frame from a well, etc. The production rate typically involves initial production that is tracked over twenty four hours, a thirty-day average, or other time frame.

The upstream oil and gas companies, as well as consultants and investment analysts can find desired well data of competing companies in these companies' annual reports, investor presentations, and other regulatory filings. The information in typically presented in text or image format, and must be individually collected for each of the desired competing companies.

However, this well data is often in text or image format and is not available in an easily accessible format that may be part of a searchable structured database or viewable in a map format within a graphical user interface (GUI).

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

Accordingly, there is a need for techniques for obtaining well data from multiple sources, compiling the obtained well data information into a form that is stored within a searchable structured database and that is also linked to a graphical user interface that can then be used to visualize the compiled well data within a digital geographical information system.

In accordance with some implementations, a method is performed at a computing system having one or more processors and storage media storing instructions for execution by the one or more processors. The method includes obtaining digital versions of public disclosures, processing the public disclosures to obtain a first set of well data information, using the first set of well data information to obtain further geographical information about the well data by searching third party databases, and generating a record for the obtained well data information in a searchable structured database. The method further includes generating a graphical user interface (GUI) that is capable of overlaying the well data information in the structured database within a geographical information software (GIS) system.

In accordance with some implementations, a computing system includes one or more processors and storage media storing one or more programs configured to be executed by the one or more processors. The one or more programs include instructions for performing the operations of the method described above. In accordance with some implementations, a non-transitory computer-readable storage medium has stored therein instructions that, when executed by the computing system, cause the computing system to perform the operations of the method described above.

Thus, systems are provided with effective methods for compiling well data information from multiple sources and generating map visualizations of the compiled well data information.

It should be understood that while examples of computer-implemented techniques for generating maps visualizing well data information using indirect information sources are described herein in the context of oil and gas wells, it will be appreciated that the techniques may be applied in other contexts to generate maps visualizations. For example, the techniques may be applied in any other mining, real-estate, or geographical contexts where specific parties are involved in geographically-based activities and where there is an online description of the activities, including state or federal filings associated with the activities.

### BRIEF DESCRIPTION OF THE DRAWINGS

In the drawings:

FIG. 1 shows a screenshot of an “Investors Overview” webpage of an oil and gas company.

FIG. 2A (Snapshot A) shows an example of well data presented in a tabular form in a public disclosure of an oil and gas company.

FIG. 2B (Snapshot B) depicts another example of well data presented within a displayed map in a public disclosure of an oil and gas company.

FIG. 3 (Snapshot C) depicts a screenshot of a query system provided for searching an online third-party oil and gas database.

FIG. 4A (Snapshot D) depicts a screenshot of another query system provided for searching another online third-party oil and gas database.

FIG. 4B (Snapshot E) depicts another screenshot while navigating away from the web page displayed in FIG. 4A.

FIG. 5A (Snapshot F) depicts another screenshot of the search system provided for the online third-party database shown in FIG. 3.

FIG. 5B (Snapshot G) depicts a screenshot of a map visualization for a well as provided within the online third-party database shown in FIG. 3.

FIG. 6 (Snapshot H) depicts a screenshot of another part of the search system provided for the online third-party database shown in FIG. 4A.

FIG. 7 (Snapshot I) depicts a screenshot of geographical data of a well as provided by the online third party database shown in FIG. 4A.

FIG. 8A-8D depicts screenshots of various aspects of the GUI provided in some embodiments of the present system.

FIG. 9 is a system diagram that illustrates a networked computer system according to some implementations.

FIG. 10 is a flowchart that illustrates a method or algorithm for compiling well data and displaying them in a graphical user interface, according to some implementations.

FIG. 11 is a block diagram a hardware machine that may be used in some implementations of the present disclosure.

FIG. 12 is a block diagram of a software system for controlling operation of the hardware machine in some implementations.

### DETAILED DESCRIPTION

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are used only to distinguish one element from another. For example, a first map could be termed a second map, and, similarly, a second map could be termed a first map, without departing from the scope of the various described implementations. The first map and the second map are both maps, but they are not the same map.

The terminology used in the description of the various implementations described herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The needs identified in the Background section and other needs are addressed with the disclosed computer-implemented techniques for generating a searchable structured database of well data information that is coupled with a GUI that allows for a map-based visualization of the well data information. Embodiments disclosed herein provide computer-based tools for navigating indirect sources such as online company websites as well as direct sources such as regional online oil and gas databases to compile well data information of companies into a single global online searchable database with search filters based on temporal, geographical and well data parameters. The generated database is also coupled with a GUI that allows the well data to be visualized using mapping software. The techniques are not well-understood or routine in that they present aggregated and integrated well data information from across multiple geographically distinct regions and multiple data sources into a single searchable database. The computer-implemented techniques described herein improve computers as a tool for discovering and compiling disparate well data information from across multiple geographically distinct regions and multiple data sources into a single searchable database through existing computer database systems.

The sections below include (i) a description of two examples involving execution of some embodiments of the disclosure, (ii) a system overview, (iii) process overview, (iv) a hardware overview, and (v) a software overview.

### Two Examples of Aggregating Well Data Information

In this section, two exemplary processes are described for aggregating oil and gas well data information for wells located in Texas, and for wells located in Wyoming.

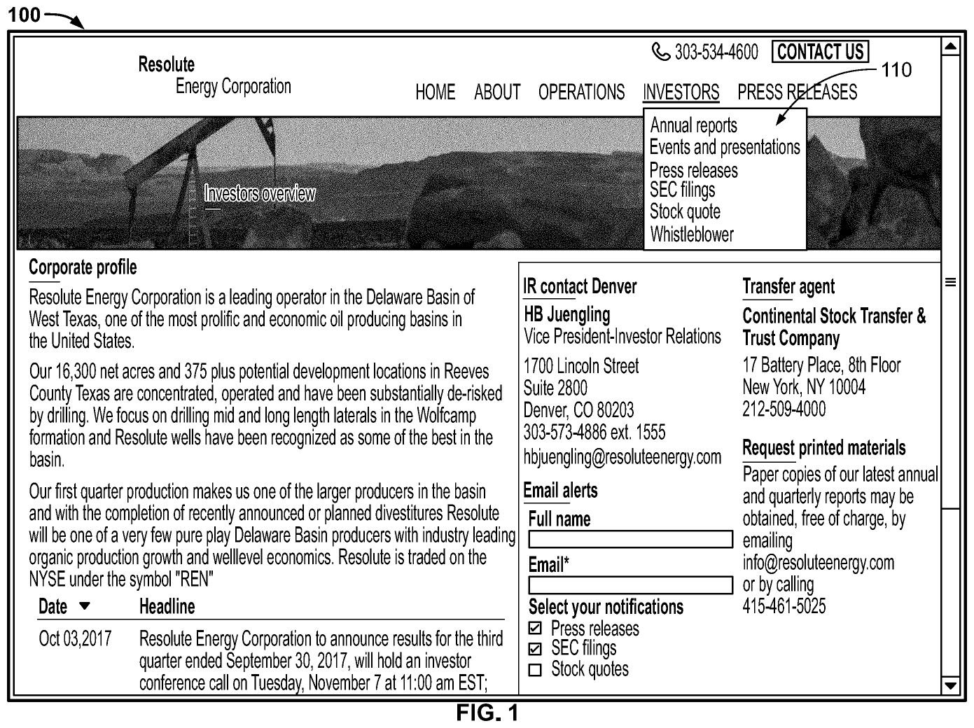

FIG. 1 shows a portion 100 of an example webpage of an oil and gas company. This example depicts an “Investors Overview” webpage belonging to the Resolute Energy Corporation. The webpage depicts a set of hyperlinks 110 providing a viewer with access to further information in company webpages associated with “Annual reports”, “Events and presentations”, “Press releases”, “SEC filings”, “Stock quote”, and “Whistleblower” respectively. As this example depicts, an “Investor relations” section of a company webpage typically provides public disclosures such as Annual Reports, Presentations, Press releases, Company Prospectus, and Quarterly Reports. Such documents may also be available on web pages of independent state and federal agencies such as, for example, the United States Securities and Exchange Commission, under individual company filings.

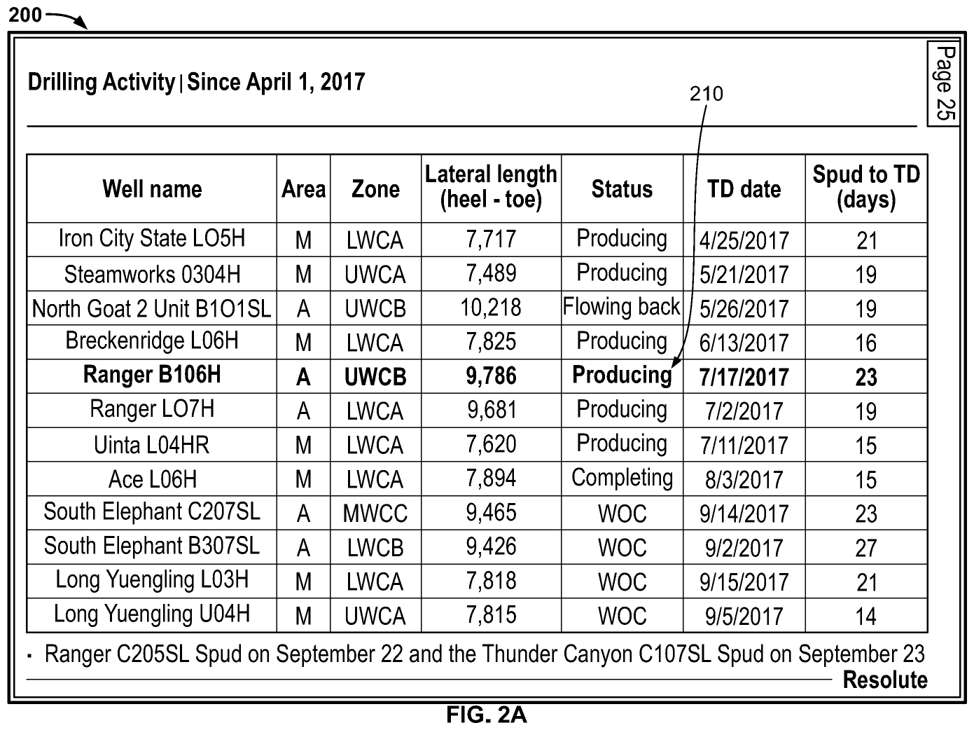

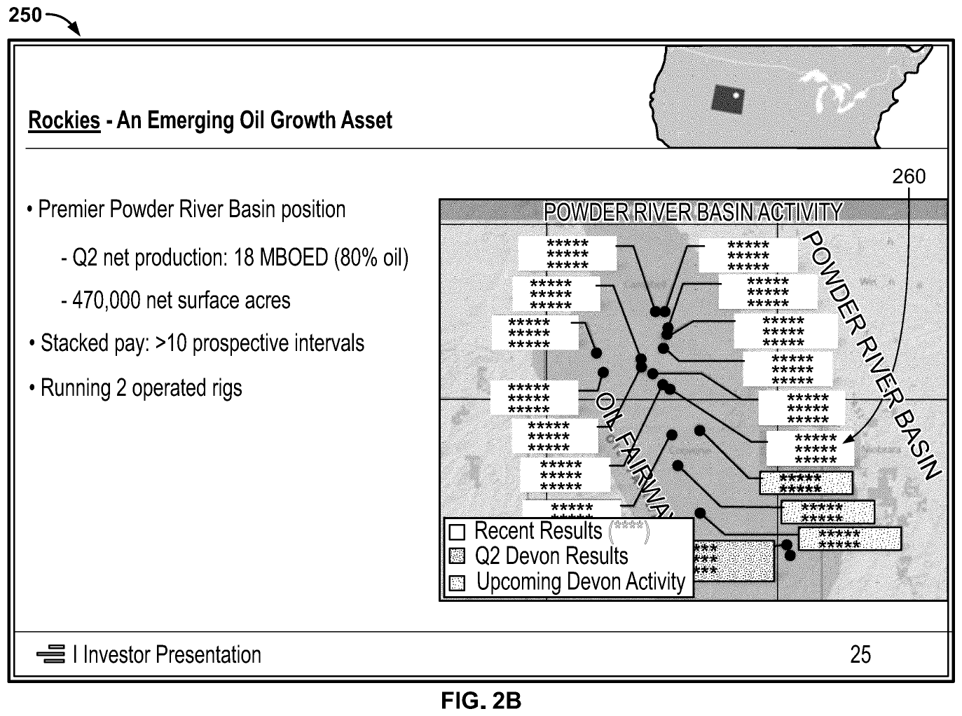

FIG. 2A shows an example of well data presented in a tabular form 200 in a public disclosure of an oil and gas company. Such information may be available as part of the public disclosure of the company and may be obtained by navigating the web pages of the company. Thus, for, example, the depicted table 200 shows the drilling activity of various wells associated with the company. The first column 210 of the table provides the names of wells including an exemplary well named “RANGER B106H”.

FIG. 2B depicts another example of well data presented in a displayed map 250 in a public disclosure of an oil and gas company. Similar to the depiction in FIG. 2A, such information may be available as part of the public disclosure of the company and may be obtained by navigating the web pages of the company. The wells are depicted as part of the layout within a map, and the depicted wells may be identified by their names. An exemplary well 260 is named “ARBALEST 66-0607H”.

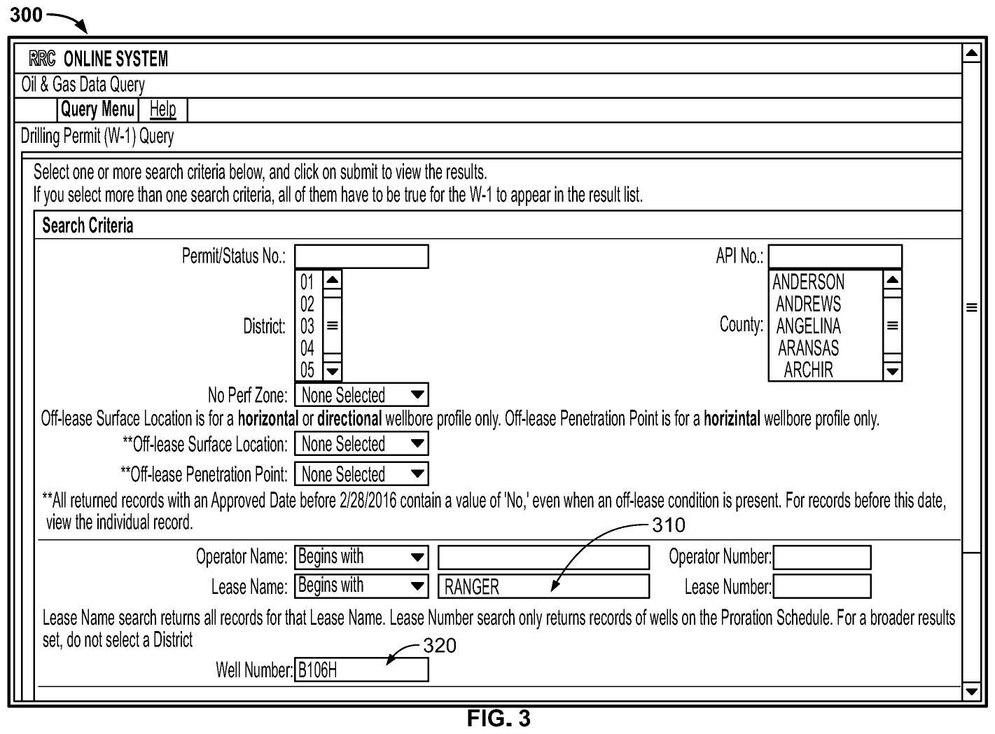

FIG. 3 depicts a screenshot of a query system graphical user interface 300 provided for searching the online Texas Railroad Commission's oil and gas database. The GUI provides a field 310 in which to enter the lease name, and the entry in this field is depicted to be “RANGER”. The GUI also provides a field 320 in which to enter the well number, depicted here to be “B106H”. This depicts the search for further information within the database for the well name “RANGER B106H” as extracted from the company's public disclosures depicted in FIG. 2A.

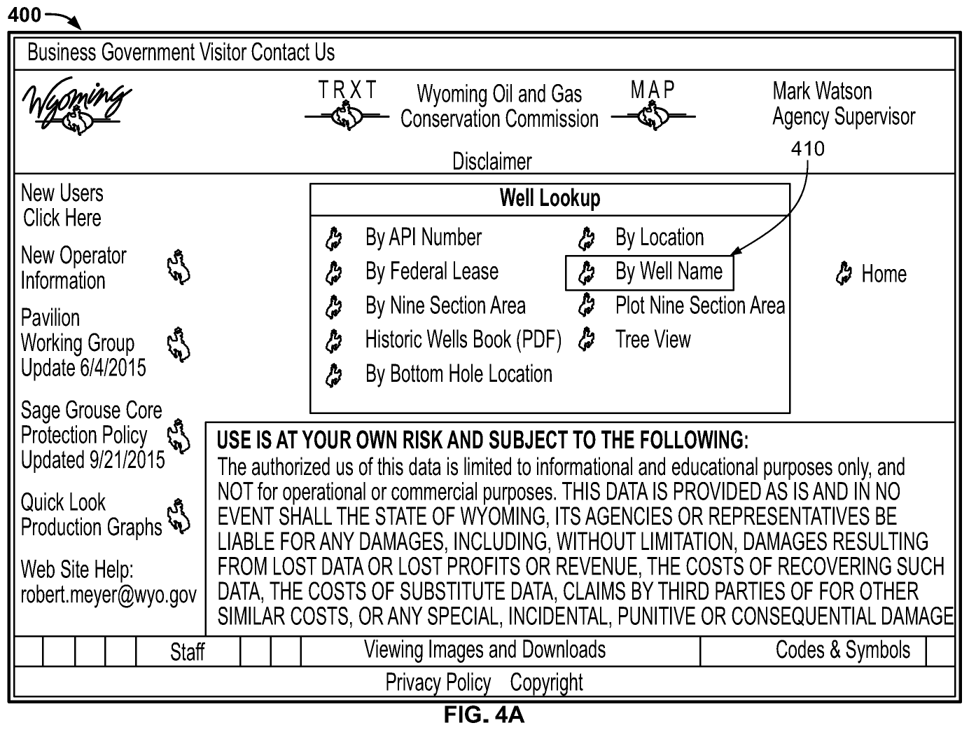

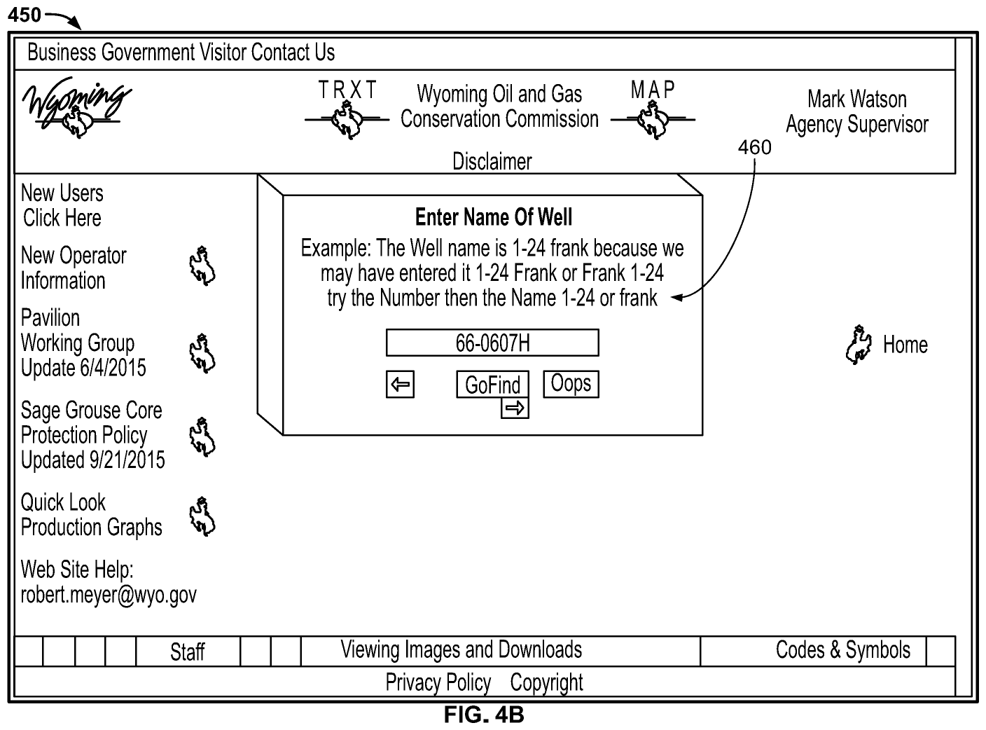

FIG. 4A depicts a screenshot of a query system graphical user interface 400 provided for searching the online Wyoming Oil and Gas Conservation Commission's oil and gas database. The GUI provides for searching by several parameters, including the parameter “Well Name”. Specifically, the GUI provides a hyperlink 410 for selection in order to search by well name. Selecting the Well Name hyperlink results in navigating away from the current web page to another web page in the GUI. This GUI 450 is depicted in FIG. 4B. The name of the well may be entered in the provided field 460 either by the alphabetical values or by numerical values. Thus, for the well name obtained from the company public disclosure “ARBALEST 66-0607H”, it is possible to search the online database by either entering “ARBALEST” or “66-0607H” (depicted).

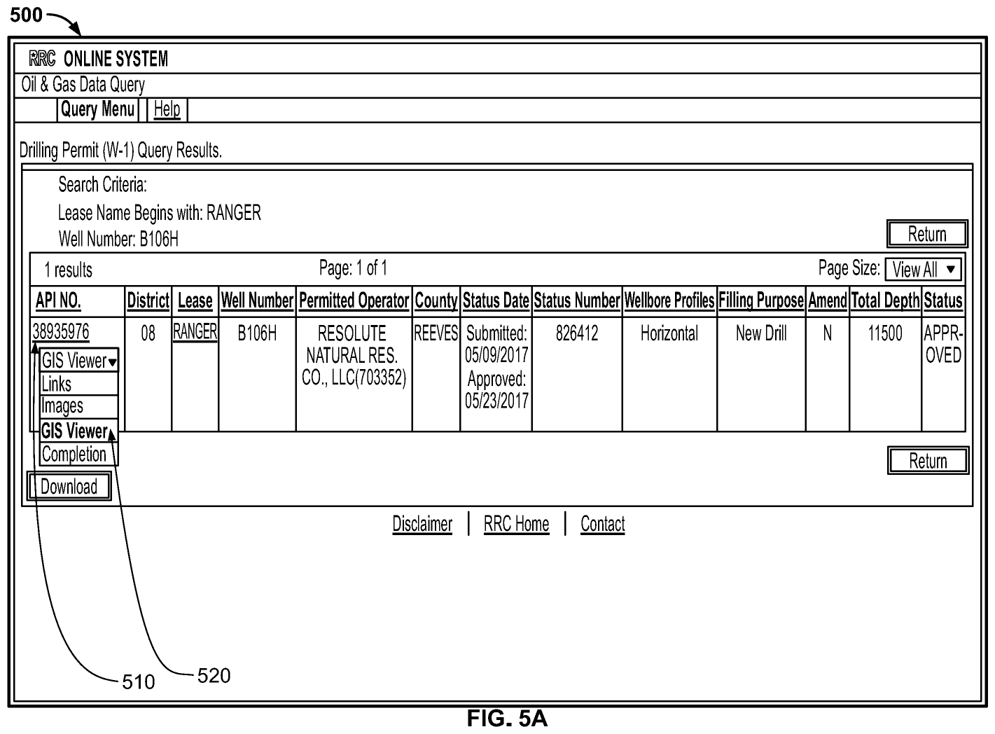

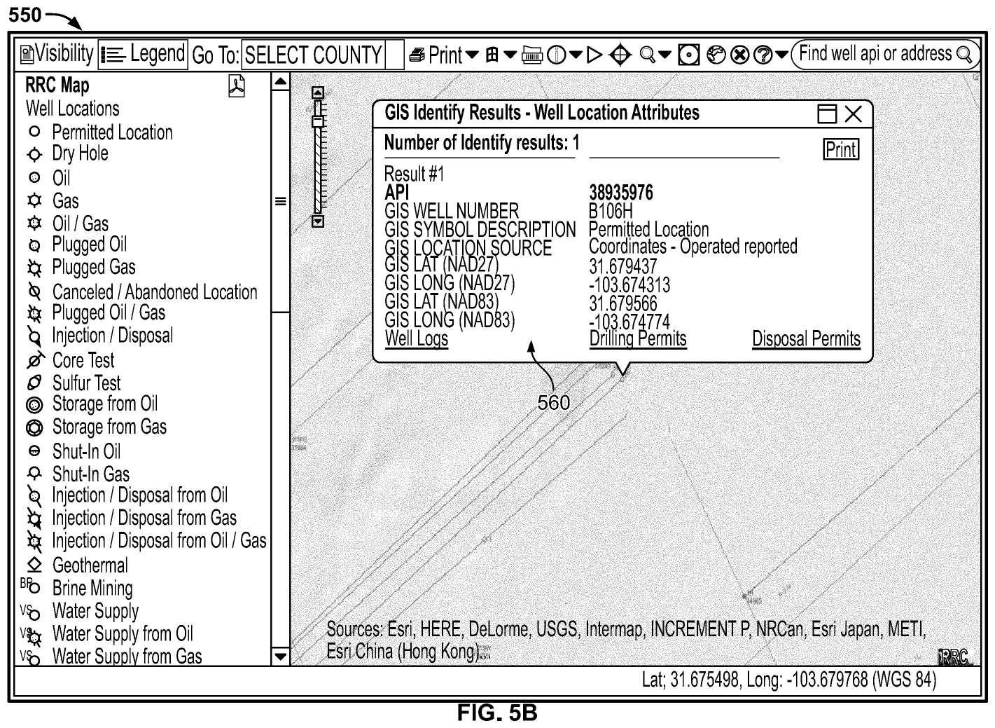

The query search depicted in FIG. 3 results in navigating to a web page depicted as a screenshot 500 in FIG. 5A. The query search results in the API number 510 of the well, shown to be “38935976”. Furthermore, next to the API number, a drop down menu 520 provides the option “GIS Viewer”. Selection of this option results in getting redirected to another web page. The screenshot of the redirected web page 550, shown in FIG. 5B, depicts the well location attributes 560 including the latitude and longitude values in both the NAD27 and NAD83 coordinate systems.

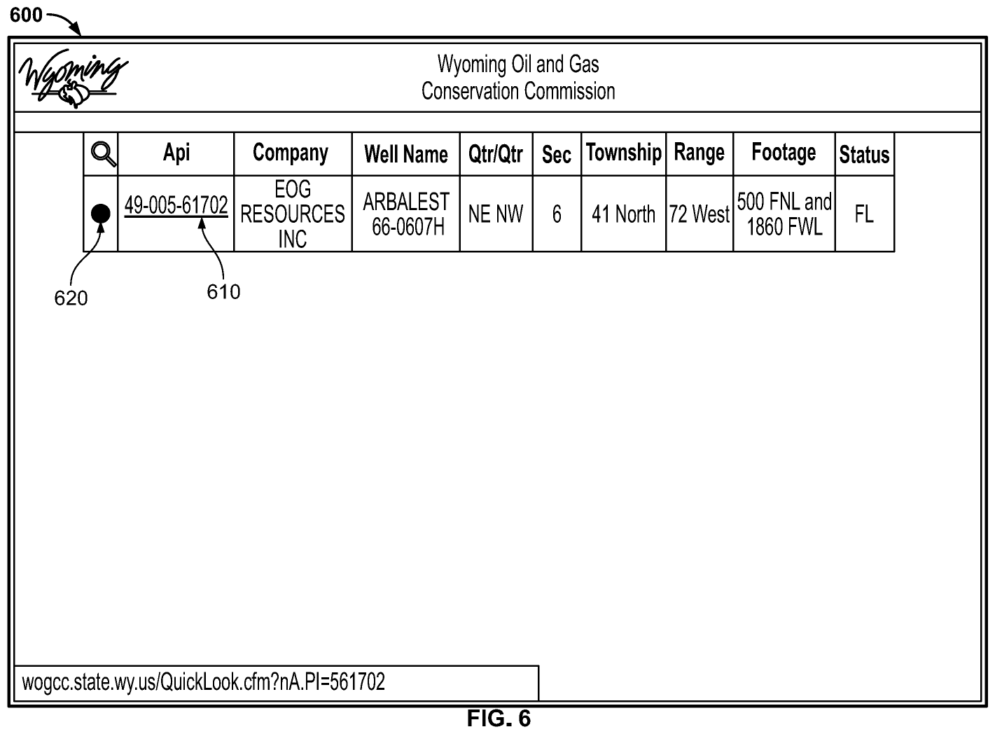

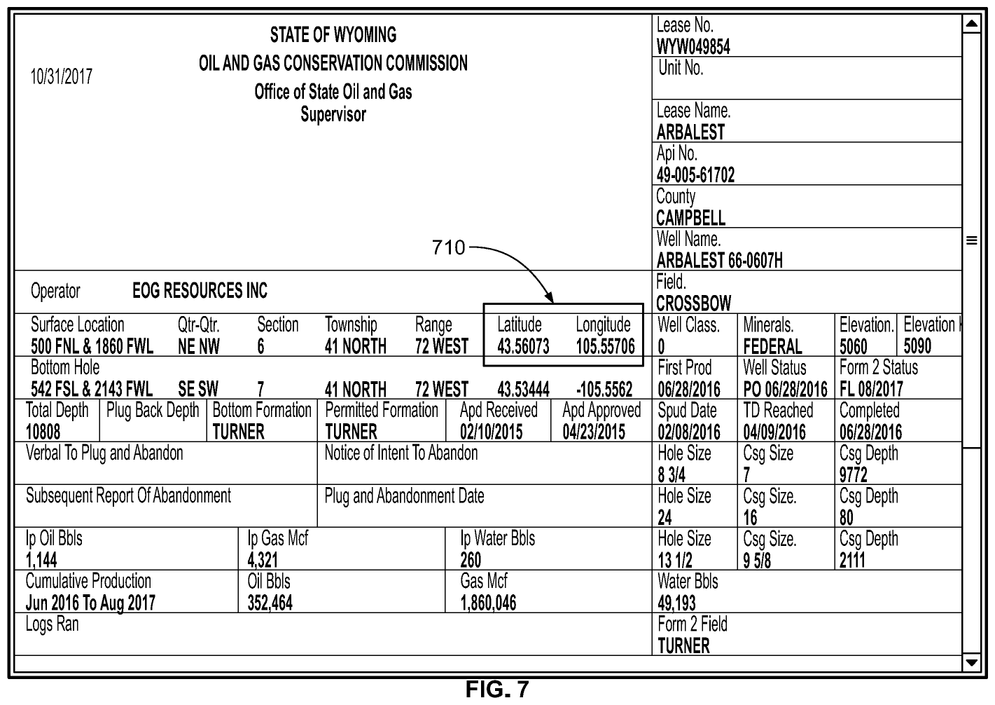

Similarly, the query search depicted in the screenshot in FIG. 4A results in navigating to a web page depicted as a screenshot 600 in FIG. 6. The query search also results in the API number of the well 610. Furthermore, there is a selectable button 620 to the left of the displayed API number. Selection of this button results in getting redirected to another web page. The screenshot 700 of the redirected web page, shown in FIG. 7, depicts a display of detailed well information including the latitude and longitude of the well in NAD83 coordinates 710.

The identified parameters associated with a particular well are then added as entries within a structured searchable database. The database is linked to a GUI for displaying the stored well data.

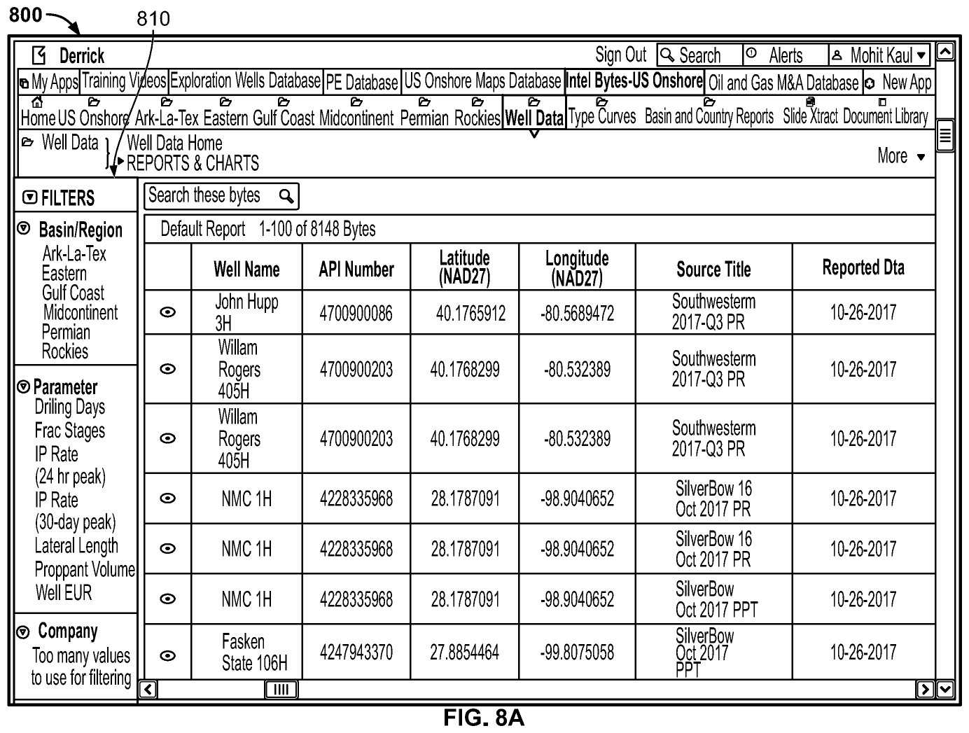

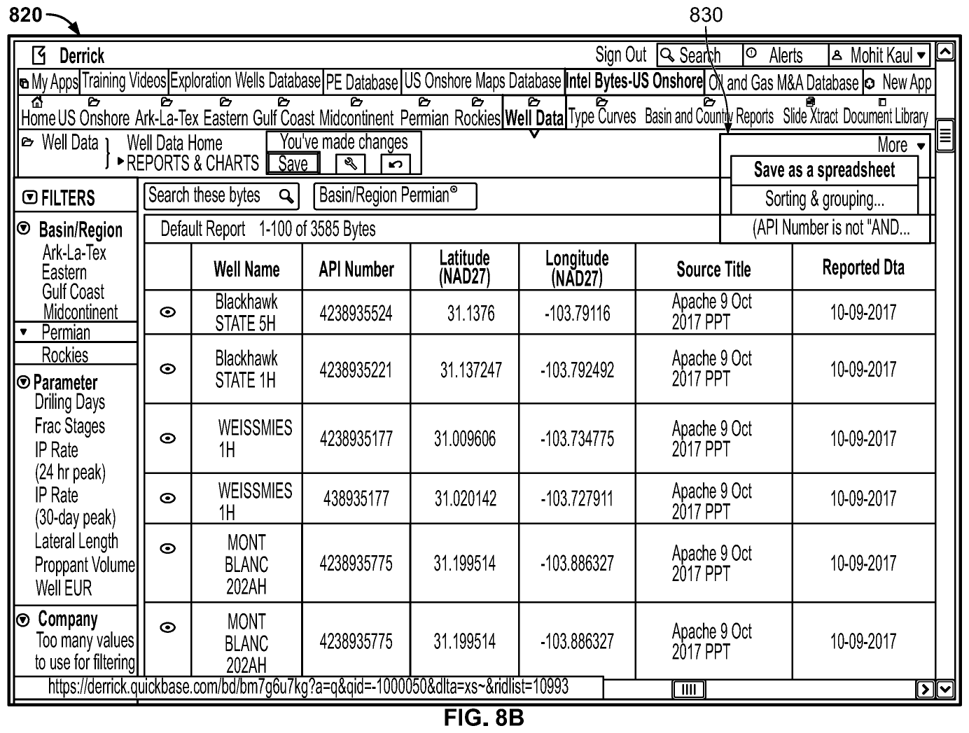

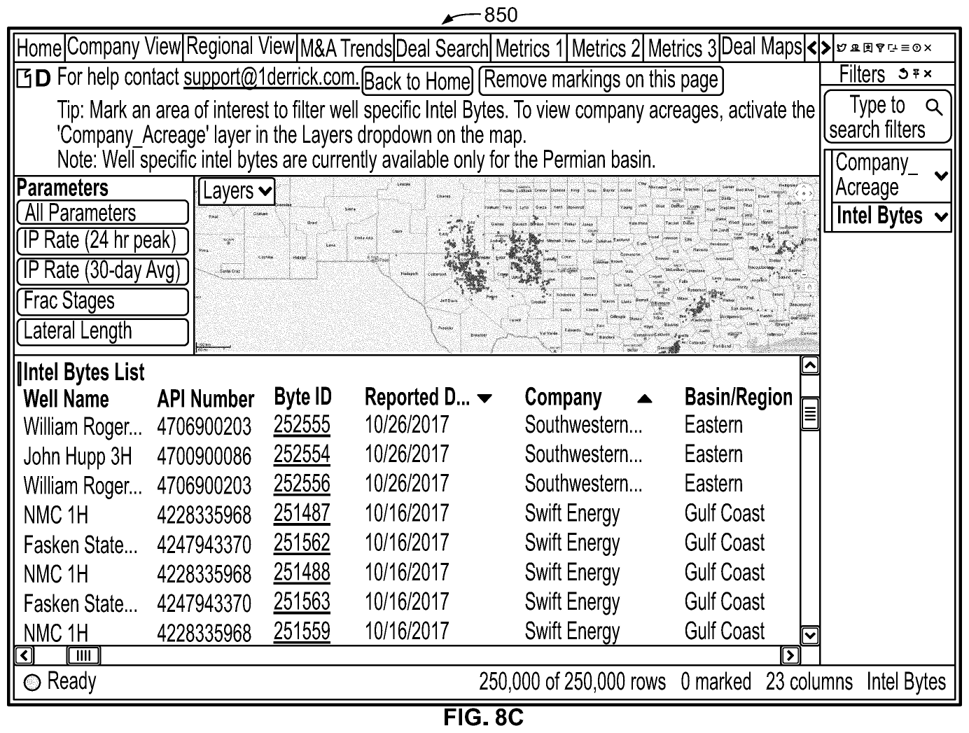

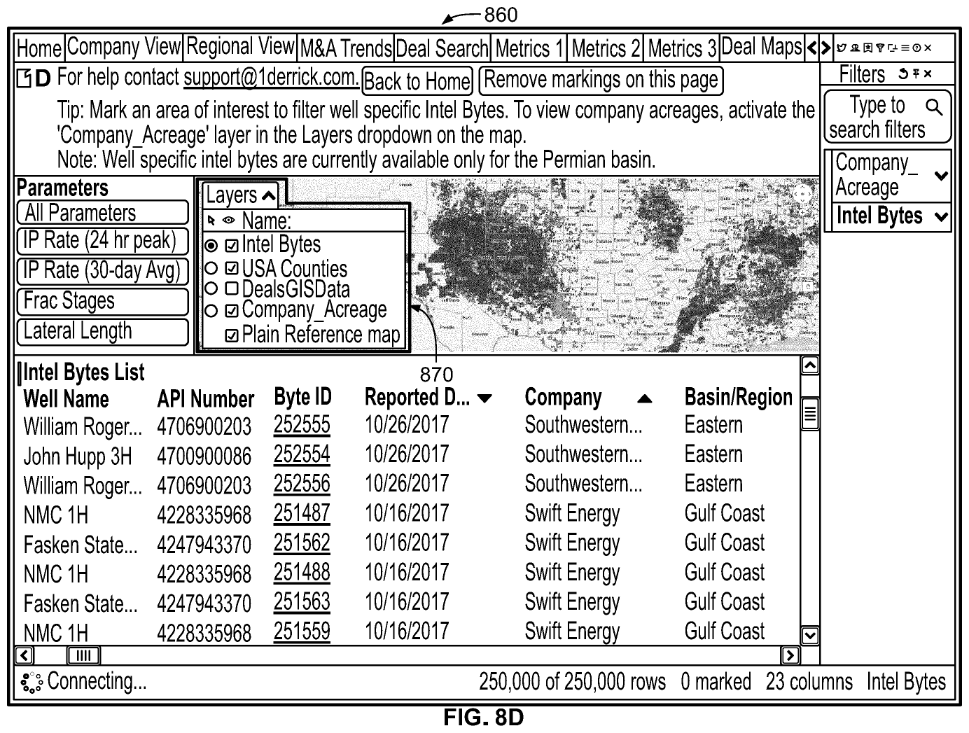

FIGS. 8A-8D are various screenshots of a GUI for displaying the compiled oil and gas well data in a tabular as well as map format.

FIG. 8A is a screenshot 800 of the GUI generated based on information in the structured searchable database that stores indirectly and directly sourced information about operational parameters of oil and gas companies. The figures display the data for several named wells, and also display search filters 810 for searching for companies in a particular basin or searching for specific parameters such as drilling dates, frac stages, IP rates (24-hour peak, 30-day average, etc.), lateral length, proppant volume, and well EUR, or searching for wells based on the owner company.

FIG. 8B is a another screenshot 820 of the GUI generated based on information in the structured searchable database. The figure displays that the data can be downloaded as a spreadsheet 830 and plotted as a map using GIS software.

FIG. 8C is a screenshot 850 of the GUI providing map visualization related to well data stored in the structured database.

FIG. 8D is a screenshot 860 of the GUI shoing that the map interface may specify overlay layers 870 so that the display may be also be overlaid with deal maps, and company acreage maps, as well as production and permit data, among others.

### System Review

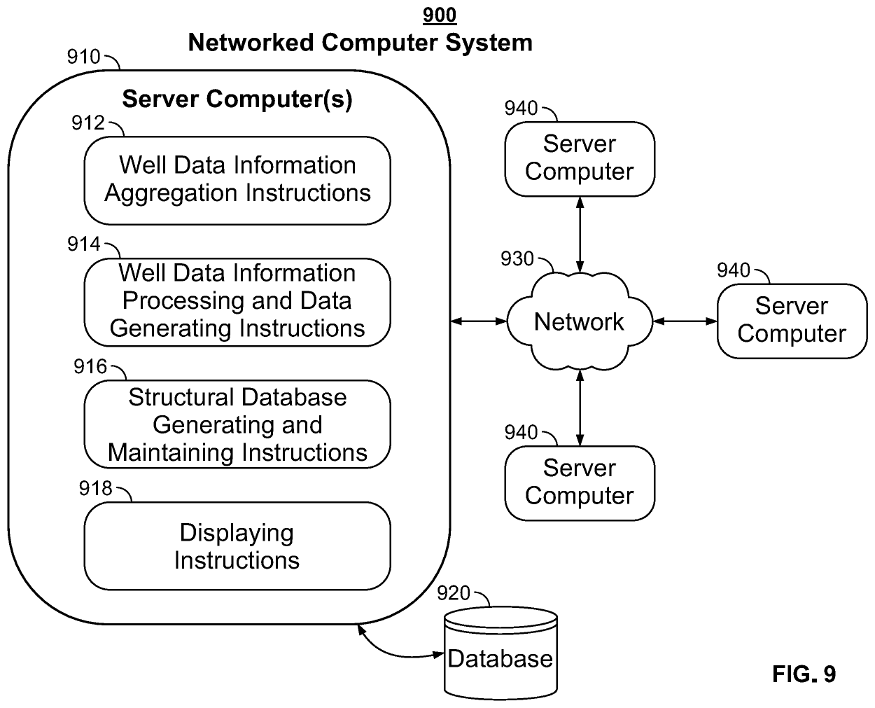

FIG. 9 is a system diagram that illustrates a computing system for generating a structured database and graphical user interface for well data information according to some implementations. In the example of FIG. 9, a networked computer system 900 may facilitate the exchange of data between one or more computers, such as one or more server computers 910 and a state database server computer 940. For example, the server computer 910 may be programmed with website navigation, database searching, and document processing instructions 912, which gather well data information from one or more oil and gas company server computers 940 including, possibly, state and federal databases 940 by periodically checking for company data updates pertaining to well data.

In some implementations, the well data information aggregation instructions 912 may poll the company server computers 940 and the state database computers 940 over a predetermined period of time. In some implementations, the well data information aggregation instructions 912 may crawl company and state database websites for new or recently recorded well data information. Data gathered by the well data information aggregation instructions 912 may be stored in a database 920 associated with the server computer 910.

In some embodiments of the present disclosure, a supervised machine learning process is trained on known oil and gas company websites to identify relevant hyperlinks such as those termed “Annual Reports”, “Presentations”, “Press releases”, “Company Prospectus”, and “Quarterly Reports”. A binary classifier may then be employed in deciding whether an unseen hyperlink presented on an online website is useful or not for the purposes of navigating the website and aggregating well data information. Thus, instructions 912 for aggregating well data information may use the trained classifiers to navigate a website of an oil and gas company to select hyperlinks that will lead to web pages that contain relevant well data documents. By using a trained classifier in this way, the well data information aggregation instructions 912 can effectively and automatically navigate a large number of hyperlinks within a website and filter for those that are relevant to gathering well data information.

In some embodiments of the present disclosure, a supervised machine learning process may be trained on websites of independent state and federal agencies such as, for example, the United States Securities and Exchange Commission, to identify relevant hyperlinks of individual company filings and proceed as in the above example.

In some embodiments of the present disclosure, a supervised machine learning process is trained on documents within a webpage that contain well data information, and likewise on documents in a web page that do not contain well data information. A binary classifier may be employed to classify unseen documents presented within a web page and decide if a document is relevant to gathering well data information or not. Thus, instructions 912 for aggregating well data information may use the trained classifier to determine whether information from a given unseen document should or should not be treated as relevant to gathering well data information. For example, the trained classifier may determine that an obtained unseen document is not relevant to well data. If so, the well data aggregation instructions may not further process the obtained document (e.g., discard the document). Alternatively, the document may be stored in a separate database, or separate portion of database 920, designated for documents for which there is low confidence that the documents pertain to well data information. The low confidence documents can be manually or automatically reviewed at a later time for classification errors. By using a trained classifier in this way, the well data aggregation instructions 912 can effectively and automatically filter large numbers of documents for those that are relevant to gathering well data information.

The server computer 910 may also be programmed with well data information processing and data generating instructions 914, in which the documents obtained as part of the public disclosures of companies, including through navigating webpages of the company website, are processed to identify well data information. The data information processing and data generating instructions 914 may parse information, such as “Annual Reports”, “Presentations”, “Press releases”, “Company Prospectus”, and “Quarterly Reports,” or other state and federal records, to generate well data information.

The identified and aggregated well data parameters include, but are not limited to, drilling days, frac stages, initial production (IP) rates over twenty-four hours and thirty-day rate averages, lateral length, proppant volume, and estimated ultimate recovery (EUR).

In some embodiments of the disclosure, a name of a well, extracted from a company's public disclosure documents, is subsequently used to search an online third-party oil and gas database in order to obtain an API number of the named well. The API number represents a unique number for any oil and gas well drilled within the United States, and is developed by the American Petroleum Institute. These online third-party databases are typically restricted by region and depict well data information associated with wells located within the region. Examples include online databases maintained by the State of Texas' Texas Railroad Commission and the State of Wyoming's Oil and Gas Conservation Commission respectively.

In some embodiments of the disclosure, the server computer 910 may also be programmed with structural searchable database generating and maintaining instructions 916, in which the generated well data are identified as parameters associated with a particular well, and are added as entries within a structured searchable database.

The server computer 910 may also be programmed with displaying instructions 918 that displays the well data through a GUI. The GUI may be web-based. That is, the GUI may be displayed in a conventional web browser application, thereby allowing users to access the database 920 without having to download and install special dedicated client software for accessing the database 920. Other types of GUIs are also possible including dedicated client applications that drive the GUI such as a mobile device application or a desktop application.

Network 930 broadly represents a combination of one or more local area networks, wide area networks, global interconnected internetworks, such as the public internet, or a combination thereof. Each such network may use or execute stored programs that implement internetworking protocols according to standards such as the Open Systems Interconnect (OSI) multi-layer networking model, including but not limited to TCP or UDP, IP, HTTP, and so forth. All computers described herein may be configured to connect to the network 130 and the disclosure presumes that all elements of FIG. 9 are communicatively coupled via network 930.

While each of the components listed above is illustrated as if located on a single computer, one or more of the components listed above may be part of and/or executed on different computers. For example, data repository 920 may be located on the same or a separate computer from another data repository 920. As another example, data repository 920 may be storage drives coupled to an enterprise server.

A “computer” may be one or more physical computers, virtual computers, and/or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, and/or any other special-purpose computing devices. Any reference to “a computer” herein may mean one or more computers, unless expressly stated otherwise. The instructions identified above are executable instructions and may comprise one or more executable files or programs that have been compiled or otherwise built based upon source code prepared in JAVA, C++, OBJECTIVE-C or any other suitable programming environment.

### Process Review

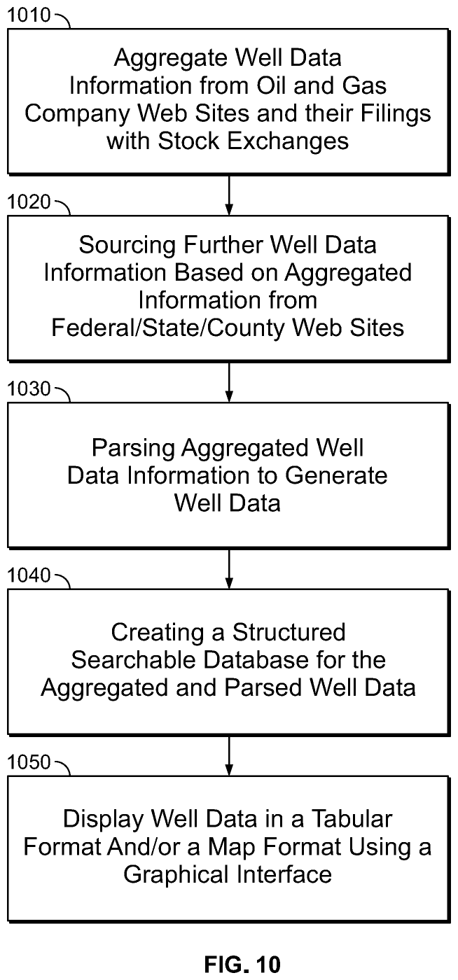

FIG. 10 is a flowchart that illustrates a method or algorithm for aggregating oil and gas well data information and displaying them in a graphical user interface, in an example embodiment.

At step 1010, the server computer 910 navigates online oil and gas company websites, obtains a first set of well data information and stores the information in a database 920. Specifically, the well data aggregation instructions 912 may access a website and/or database related to an oil and gas company server computer 940 and search for well data information. The well data aggregation instructions 912 may download files related to the company's oil and gas well properties in some implementations.

FIG. 1 is an example of an oil and gas company's website. FIG. 2A and FIG. 2B are examples of well data information that can be downloaded from such a website as part of the company's public disclosures.

At step 1020, the server computer 910 identifies federal/state/county websites for sourcing more well data information based on the already aggregated and parsed information from step 1020. In an example embodiment, the data generating and processing instructions 914 may identify geographical information such as the latitude and longitude data for a well identified by well name, which may be provided in the website of a federal/state/county website, for example. This information may be manually entered or extracted using computers, optical character recognition software, and machine learning algorithms.

At step 1030, the server computer 910 parses the obtained documents to generate well data. For example, the data generating and processing instructions 914 may parse the downloaded public disclosure documents to identify the well name, the well status, the associated company, and well parameters such as the lateral length for the well, among other data. Subsequently, a new entry for a specific well may be created in a structured database if this well name is not already present in the database. This information may be manually entered or extracted using computers, optical character recognition software, and machine learning algorithms.

FIG. 3, FIG. 4A, and FIG. 4B are examples of such a website. FIG. 3 depicts a screenshot of a query system graphical user interface 300 provided for searching the online Texas Railroad Commission's oil and gas database using the well data information gathered from step 1020. FIG. 4A and FIG. 4B depicts a screenshots of a query system graphical user interface 400 provided for searching the online Wyoming Oil and Gas Conservation Commission's oil and gas database using the well data information gathered from step 1020.

At step 1040, the well data information aggregated and compiled from the company websites as well as the federal/state/county databases is entered into a structured searchable database. The extracted information in the structured searchable database include well data tagged to API number, latitude and longitude coordinates. The latitude and longitude may be stored in NAD27 coordinates. In the case when geographical coordinates are extracted in a format other than NAD27 coordinate, the attributes may be convented into NAD27 coordinates.

At step 1050, in response to user input, the server computer 910 may display, in a graphical user interface (GUI), the well data stored in the database 920. FIG. 8A-8D depict the GUI in example embodiments. The GUI may contain improved search filters unique to the oil and gas industry such as searching for well data. Search filters include, but are not limited to, searching for lls in a particular basin or searching for specific parameters such as drilling dates, frac stages, IP rates (24-hour peak, 30-day average, etc.), lateral length, proppant volume, EUR, etc. Possible map displays include downloading well data tagged to the API number, latitude and longitude into a spreadsheet and plotting the data on GIS software. Users can also view the maps on a map interface provided in some embodiments of the disclosure. The map interface may also be overlaid with deal maps, and company acreage maps, as well as production and permit data. The multiple search and filter options allow users to draw unique insights for competitive intelligence analysis.

### Hardware Review

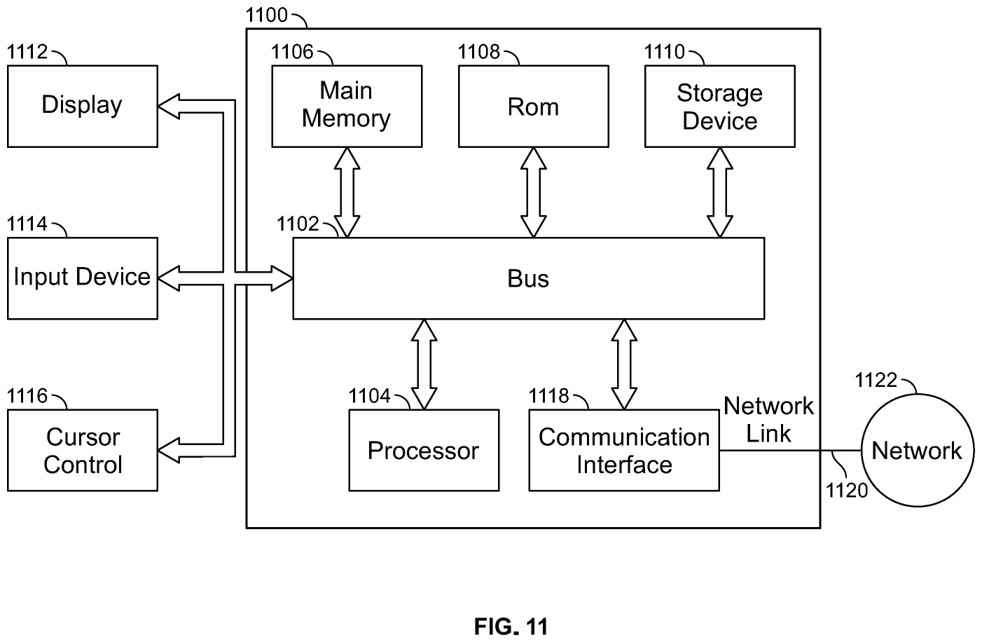

Embodiments of the present disclosure, in some implementations, is implemented using a computing system comprising one or more processors and storage media. The one or more processors and memory may be provided by one or more hardware machines. FIG. 11 illustrates an example of a basic hardware machine 1100 that may be used in some implementations. Hardware machine 1100 and its hardware components, including their connections, relationships, and functions, is meant to be exemplary only, and not meant to limit implementations of the present disclosure. Other hardware machines suitable for implementing the embodiments may have different components, including components with different connections, relationships, and functions.

Hardware machine 1100 includes a bus 1102 or other communication mechanism for addressing a main memory 1106 and for transferring data between and among the various components of hardware machine 1100.

Hardware machine 1100 also includes a processor 1104 coupled with bus 1102 for processing information. Processor 1104 may be a general-purpose microprocessor, a system on a chip (SoC), or another hardware processor.

Main memory 1106, such as a random-access memory (RAM) or other dynamic storage device, is coupled to bus 1102 for storing information and software instructions to be executed by processor 1104. Main memory 1106 also may be used for storing temporary variables or other intermediate information during execution of software instructions to be executed by processor 1104.

Software instructions, when stored in storage media accessible to processor 1104, render hardware machine 1100 into a special-purpose computing machine that is customized to perform the operations specified in the software instructions. The terms “software”, “software instructions”, “computer program”, “computer-executable instructions”, and “processor-executable instructions” are to be broadly construed to cover any machine-readable information, whether or not human-readable, for instructing a machine to perform specific operations, and including, but not limited to, application software, desktop applications, scripts, binaries, operating systems, device drivers, boot loaders, shells, utilities, system software, JAVASCRIPT, web pages, web applications, mobile applications, plugins, embedded software, microcode, compilers, debuggers, interpreters, virtual machines, linkers, and text editors.

Hardware machine 1100 includes a read-only memory (ROM) 1108 or other static storage device coupled to bus 1102 for storing static information and software instructions for a processor 1104.

A mass storage device 1110 is coupled to bus 1102 for persistently storing information and software instructions on fixed or removable media, such as magnetic, optical, solid-state, magnetic-optical, flash memory, or any other available mass storage technology. The mass storage may be shared on a network, or it may be dedicated mass storage. Mass storage device 1110 may store a body of program and data for directing operation of hardware machine 1100, including an operating system, user application programs, driver, and other support files, as well as other data files of all sorts.

Hardware machine 1100 may be coupled via bus 1102 to a display 1112, such as a liquid crystal display (LCD) or other electronic visual display, for displaying information to a computer user. A touch sensitive surface incorporating touch detection technology (e.g., resistive, capacitive, etc.) may be incorporated with display 1112 to form a touch sensitive display for communicating touch gesture (e.g., finger or stylus) input to processor 1104.

An input device 1114 may be coupled to bus 1102 for communicating information and command selections to processor 1104. Input device 1114 may include alphanumeric and other keys. Input device 1114 may include one or more physical buttons or switches such as, for example, a power (on/off) button, a “home” button, volume control buttons, or the like.

A cursor control 1116, such as a mouse, a trackball, touchpad, touch-sensitive surface, or cursor direction keys for communicating direction information and command selections to processor 1104 and for controlling cursor movement on display 1112, may be coupled to bus 1102. Cursor control 1116 may have two degrees of freedom in two axes, a first axis (e.g., x) and a second axis (e.g., y), that allows the device to specify positions in a plane. Cursor control 1116 may have more degrees of freedom with a third axis (e.g., z). For example, cursor control 1116 may have three translational degrees of freedom (e.g., surge, heave, and sway) in three perpendicular axes, that allows the device to specify position in the three axes. Cursor control 1116 may have three rotational degrees of freedom (e.g., pitch, yaw, roll) about three perpendicular axes, that allows the device to specify an orientation about the three axes.

While one or more of display 1112, input device 1114, and cursor control 1116 may be external components (i.e., peripheral devices) of hardware machine 1100, some or all of display 1112, input device 1114, and cursor control 1116 may be integrated as part of the form factor of hardware machine 1100.

A function or operation of embodiments of the present disclosure may be performed by hardware machine 1100 in response to processor 1104 executing one or more programs of software instructions contained in main memory 1106. Such software instructions may be read into main memory 1106 from another storage medium, such as a storage device 1110. Execution of the software instructions contained in main memory 1106 cause processor 1104 to perform the function or operation.

While a function or operation of embodiments of the present disclosure may be implemented entirely with software instructions, hard-wired or programmable circuitry of hardware machine 1100 (e.g., an ASIC, a FPGA, or the like) may be used in place of or in combination with software instructions to perform the function or operation.

The term “storage media” as used herein refers to any non-transitory media that store data and/or software instructions that cause a hardware machine to operate in a specific fashion. Such storage media may comprise non-volatile media and/or volatile media. Non-volatile media includes, for example, non-volatile random access memory (NVRAM), flash memory, optical disks, magnetic disks, or solid-state drives, such as storage device 1110. Volatile media includes dynamic memory, such as main memory 1106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more software instructions to processor 1104 for execution. For example, the software instructions may initially be carried on a magnetic disk or solid-state drive of a remote computer. The remote computer can load the software instructions into its dynamic memory and send the software instructions over a data communications network. Hardware machine 1100 can receive the data over the data communications network and appropriate circuitry can place the data on bus 1102. Bus 1102 carries the data to main memory 1106, from which processor 1104 retrieves and executes the software instructions. The software instructions received by main memory 1106 may optionally be stored on storage device 1110 either before or after execution by processor 1104.

Hardware machine 1100 may include a communication interface 1118 coupled to bus 1102. Communication interface 1118 provides a two-way data communication coupling to a wired or wireless network link 1120 that connects hardware machine 1100 to a data communications network 1122 (e.g., a local area network (LAN), a wide area network (WAN), a wireless local area network (WLAN), a metropolitan area network (MAN), a storage area network (SAN), etc.). Network link 1120 provides data communication through network 1122 to one or more other networked devices.

Communication interface 1118 may send and receive electrical, electromagnetic, or optical signals that carry digital data streams representing various types of information. For example, communication interface 1118 may be implemented by a wired network interface card, a wireless network interface card with an integrated radio antenna, or a modem.

Network link 1120 may provide a connection through network 1122 to a host computer or to data equipment operated by an Internet Service Provider (ISP). The ISP may in turn provide data communication services through the world-wide packet data communication network now commonly referred to as the “Internet”. Network 1122 and Internet use electrical, electromagnetic or optical signals that carry digital data streams. The signals through the various networks and the signals on network link 1120 and through communication interface 1118, which carry the digital data to and from hardware machine 1100, are example forms of transmission media.

Hardware machine 1100 can send messages and receive data, including program code, through network 1122, network link 1120, and communication interface 1118. In the Internet example, a server might transmit a requested code for an application program through Internet, ISP, and network 1122 and communication interface 1118.

The received code may be executed by processor 1104 as it is received, and/or stored in storage device 1110, or other non-volatile storage for later execution.

### Software Review

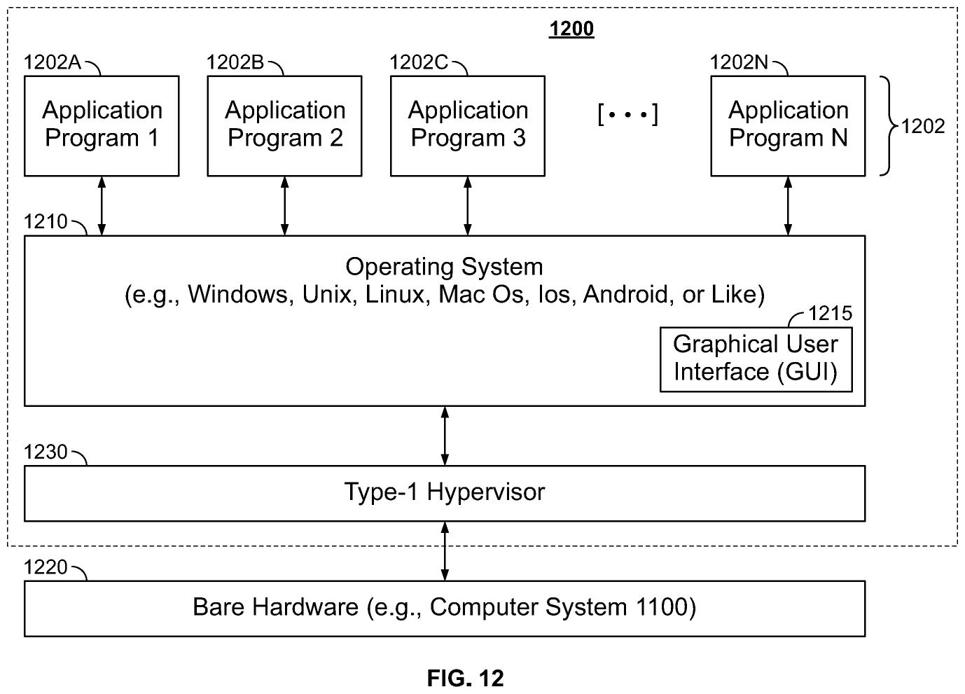

FIG. 12 illustrates basic software system 1200 that may be employed for controlling the operation of hardware machine 1100 of FIG. 11, according to an embodiment of the present disclosure. Software system 1200 and its software components, including their connections, relationships, and functions, is meant to be exemplary only, and not meant to limit implementations of the present disclosure. Other software systems suitable for implementing embodiments of the present disclosure may have different components, including components with different connections, relationships, and functions.

Software system 1200 is provided for directing the operation of hardware machine 1100. Software system 1200 may be stored in system memory (RAM) 1106 and on fixed storage (e.g., hard disk or flash memory) 1110.

Software system 1200 includes a kernel or operating system (OS) 1210. OS 1210 manages low-level aspects of computer operation, including managing execution of processes, memory allocation, file input and output (I/O), and device I/O.

Software system 1200 includes one or more application programs, represented as 1202A, 1202B, 1202C . . . 1202N, that may be “loaded” (e.g., transferred from fixed storage 1110 into memory 1106) for execution by hardware machine 1100. The applications or other software intended for use on hardware machine 1100 may also be stored as a set of downloadable computer-executable instructions, for example, for downloading and installation from an Internet location (e.g., a Web server, an app store, or other online service).

Software system 1200 includes a graphical user interface (GUI) 1215, for receiving user commands and data in a graphical (e.g., “point-and-click” or “touch gesture”) fashion. These inputs, in turn, may be acted upon by the system 1200 in accordance with instructions from operating system 1210 and/or application(s) 1202. GUI 1215 also serves to display the results of operation from the OS 1210 and applications 1202, whereupon the user may supply additional inputs or terminate the session (e.g., log off).

Software system 1200 can execute directly on bare hardware 1220 (e.g., machine 1100). Alternatively, a “Type-1” hypervisor 1230 may be interposed between the bare hardware 1220 and OS 1210 as part of software system 1200. Hypervisor 1230 acts as a software “cushion” or virtualization layer between the OS 1210 and bare hardware 1220. Hypervisor 1230 instantiates and runs one or more virtual machine instances. Each virtual machine instance comprises a “guest” operating system, such as OS 1210, and one or more applications, such as applications 1202, designed to execute on the guest operating system. Hypervisor 1230 presents the guest operating systems with a virtual operating platform and manages the execution of the guest operating systems.

Hypervisor 1230 may allow a guest operating system to run as if it is running on bare hardware 1220 directly. In this case, the guest operating system as configured to execute on bare hardware 1220 can also execute on hypervisor 1230. In other words, hypervisor 1230 may provide full hardware virtualization to the guest operating system. Alternatively, hypervisor 1230 may provide para-virtualization to the guest operating system. In this case, the guest operating system is “aware” that it executes on hypervisor 1230 and is specially designed or configured to execute on hypervisor 1230.

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A method performed by a computing system comprising one or more processors and storage media, the storage media storing one or more programs executed by the one or more processors to perform the method, the method comprising:
navigating websites and aggregating well data information in a database;
processing the aggregated well data information to extract a first set of well data;
navigating to online websites and obtaining a second set of well data based on the extracted first set of well data;
generating entries for the extracted first and second set of well data in a searchable structured database; and
in response to user input, displaying, in a graphical user interface (GUI), the well data stored in the database.

2. The method of claim 1, wherein aggregating well data information comprises downloading digital versions of well data information from the websites.

3. The method of claim 2, wherein the digital version of the well data information is text-based; and wherein the processing of the aggregated well data information is based, at least in part, on parsing text of the digital versions to extract well data.

4. The method of claim 1, wherein navigating websites is based, at least in part, on using a machine learning binary classifier to classify a webpage of a website as either relevant or not relevant to aggregating well data information.

5. The method of claim 1, wherein aggregating well data information is based, at least in part, on using a machine learning binary classifier to classify information presented in a website as either relevant or not relevant to well data.

6. A data processing and displaying system that comprises one or more hardware processors and one or more memory modules that store instructions that when executed by the one or more processors perform operations, comprising:
navigating websites and aggregating well data information in a database;
processing the aggregated well data information to extract a first set of well data;
navigating to online websites and obtaining a second set of well data based on the extracted first set of well data;
generating entries for the extracted first and second set of well data in a searchable structured database; and
in response to user input, displaying, in a graphical user interface (GUI), the well data stored in the database.

7. The system of claim 6, wherein the operation of aggregating well data information comprises downloading digital versions of well data information from the websites.

8. The system of claim 7, wherein the digital version of the well data information is text-based; and wherein the operation of processing of the aggregated well data information is based, at least in part, on parsing text of the digital versions to extract well data.

9. The system of claim 6, wherein the operation of navigating websites is based, at least in part, on using a machine learning binary classifier to classify a webpage of a website as either relevant or not relevant to aggregating well data information.

10. The system of claim 6, wherein the operation of aggregating well data information is based, at least in part, on using a machine learning binary classifier to classify information presented in a website as either relevant or not relevant to well data.

11. A computer-readable data storage medium storing one or more sequences of instructions which, when executed using one or more digital data processors, cause operations comprising:
navigating websites and aggregating well data information in a database;
processing the aggregated well data information to extract a first set of well data;
navigating to online websites and obtaining a second set of well data based on the extracted first set of well data;
generating entries for the extracted first and second set of well data in a searchable structured database; and
in response to user input, displaying, in a graphical user interface (GUI), the well data stored in the database.

12. The computer-readable data storage medium of claim 11, wherein the operation of aggregating well data information comprises downloading digital versions of well data information from the websites.

13. The computer-readable data storage medium of claim 12, wherein the digital version of the well data information is text-based; and wherein the operation of processing of the aggregated well data information is based, at least in part, on parsing text of the digital versions to extract well data.

14. The computer-readable data storage medium of claim 11, wherein the operation of navigating websites is based, at least in part, on using a machine learning binary classifier to classify a webpage of a website as either relevant or not relevant to aggregating well data information.

15. The computer-readable data storage medium of claim 11, wherein the operation of aggregating well data information is based, at least in part, on using a machine learning binary classifier to classify information presented in a website as either relevant or not relevant to well data.
